(19) United States
(12) Patent Application Publication
(10) Pub. No.: US 2023/0061768 A1
(43) Pub. Date: Mar. 2, 2023

(54) THERMAL INKJET NOZZLE DEVICE

(71) Applicant: Memjet Technology Limited, Dublin (IE)

(72) Inventor: Glenn HORROCKS, North Ryde NSW (AU)

(21) Appl. No.: 17/822,372

(22) Filed: Aug. 25, 2022

Related U.S. Application Data
(60) Provisional application No. 63/237,931, filed on Aug. 27, 2021.

(51) Int. Cl. B41J 2/14

(52) U.S. Cl. CPC B41J 2/14032

(57) ABSTRACT

An inkjet nozzle device includes: a bubble chamber having a heating element for generating a vapour bubble and an orifice positioned for communicating an impulse from the vapour bubble; a first inlet for supplying a first fluid to the bubble chamber; an ejection chamber having a roof defining a nozzle and an adjoining wall between the ejection chamber and the bubble chamber, the adjoining wall defining the orifice; and a second inlet for supplying a second fluid to the ejection chamber. In use, the first and second fluids form a fluidic interface at the orifice and the vapour bubble provides the impulse to the second fluid in the ejection chamber via the orifice, such that the impulse ejects the second fluid from the nozzle.

### CROSS REFERENCE TO RELATED APPLICATIONS

This application claims priority to and the benefit of U.S. Provisional Patent Application No. 63/237,931, filed on Aug. 27, 2021, the disclosure of which is incorporated herein by reference in its entirety for all purposes.

### FIELD OF THE INVENTION

This invention relates to inkjet nozzle devices. It has been developed primarily for broadening a range of fluids that are ejectable from inkjet nozzles using thermal inkjet technology.

### BACKGROUND OF THE INVENTION

The Applicant has developed a range of Memjet® inkjet printers as described in, for example, WO2011/143700, WO2011/143699 and WO2009/089567, the contents of which are herein incorporated by reference. Memjet® printers typically employ a stationary pagewidth printhead in combination with a feed mechanism which feeds print media past the printhead in a single pass. Memjet® printers therefore provide much higher printing speeds than conventional scanning inkjet printers.

An inkjet printhead is comprised of a plurality (typically thousands) of individual inkjet nozzle devices, each supplied with ink. Each inkjet nozzle device typically comprises a nozzle chamber having a nozzle aperture and an actuator for ejecting ink through the nozzle aperture. The design space for inkjet nozzle devices is vast and a plethora of different nozzle devices have been described in the patent literature, including different types of actuators and different device configurations.

Drop-on-demand inkjet nozzle devices used in commercial printheads usually employ either thermal bubble-forming actuators or piezo actuators. Thermal bubble-forming inkjet devices have the advantages of low-cost and high nozzle density, achievable via MEMS fabrication processes; on the other hand, piezo inkjet devices have the advantage of compatibility with a wide range of fluids, such as non-aqueous inks and high viscosity inks.

While inkjet printing technologies have enjoyed considerable commercial success over the past few decades, there remains a need for new inkjet technologies that potentially combine the advantages of thermal bubble-forming and piezo technologies. The Applicant has previously described MEMS thermal bend actuators as a potential new means for inkjet actuation. A thermal bend actuator uses a thermoelastic layer mechanically cooperating with a passive layer to provide a bending motion via thermal expansion of the thermoelastic layer relative to the passive layer. As described in many of the Applicant's previous patents (see, for example, U.S. Pat. Nos. 6,623,101 and 7,794,056, the contents of which are incorporated herein by reference) the thermally-actuated bending motion of a paddle can be used to provide the requisite impulse for droplet ejection, thereby expanding the range of ejectable fluids compared to conventional thermal bubble-forming devices. However, MEMS inkjet devices with moving parts are difficult to fabricate and require careful choice of materials to achieve acceptable lifetimes.

It would therefore be desirable to provide an alternative MEMS inkjet device capable of ejecting a broader range of fluids than conventional thermal bubble-forming devices. It would further be desirable for such an alternative MEMS inkjet device to have no moving parts and be capable of fabrication via conventional MEMS processes.

### SUMMARY OF INVENTION

According to the present invention, there is provided an inkjet nozzle device comprising:

a bubble chamber having a heating element for generating a vapour bubble and an orifice positioned for communicating an impulse from the vapour bubble;

a first inlet for supplying a first fluid to the bubble chamber;

an ejection chamber having a roof defining a nozzle and an adjoining wall between the ejection chamber and the bubble chamber, the adjoining wall defining the orifice; and

a second inlet for supplying a second fluid to the ejection chamber,

wherein, in use, the first and second fluids form a fluidic interface at the orifice and the vapour bubble provides the impulse to the second fluid in the ejection chamber via the orifice, said impulse ejecting the second fluid from the nozzle.

Advantageously, the inkjet nozzle device ejects droplets of the second fluid (“ink”) by means of an impulse provided by the first fluid (“impulse fluid”). Therefore, the range of fluids that may be used as the second fluid is not limited by the demands of typical thermal inkjet nozzle devices (e.g. bubble-forming ability, viscosity, compatibility with heating element materials, thermally-induced kogative characteristics, thermally-induced corrosive characteristics etc.). For example, the second fluid may contain a high concentration of polymer, which may be suitable for use as a UV-curable ink or as a binder fluid for 3D printing applications.

Likewise, the first fluid can have properties tailored solely for bubble formation without the complex demands of typical ink formulations, which are required to compromise on various properties (e.g. ejectability, stability, image quality, media penetration, dot gain, corrosion, kogation, dehydration, dry-time, decap, device lifetime etc.).

Accordingly, the thermal inkjet device described herein can compete with, for example, piezo devices in terms of the range of fluids that are ejectable from the device. Moreover, the thermal inkjet device can be fabricated using established MEMS fabrication techniques used for conventional thermal inkjet devices. Furthermore, the thermal inkjet nozzle device has no moving parts, in contrast with thermally-actuated mechanical devices, such as those described in U.S. Pat. No. 7,794,056. These and other advantages will be readily apparent to the person skilled in the art from the detailed description hereinbelow.

The orifice is typically defined in a floor of the ejection chamber opposite the nozzle and may have a shape mirroring the nozzle or have another shape. Likewise, the orifice and nozzle may be similarly sized or have different sizes. The nozzle may have any suitable shape, but is typically either circular or elliptical. In the case of elliptical nozzle apertures, a major of axis of the elliptical nozzle is preferably aligned with and extends parallel with a central longitudinal axis of the heating element for optimum ejection efficiency.

Preferably, the heating element is disposed on a floor of the bubble chamber. In some embodiments, the heating element takes the form of an elongate rectangular bar as described in, for example, U.S. Pat. No. 9,044,945, the contents of which are incorporated herein by reference.

Preferably, the heating element, the orifice and the nozzle are aligned in a direction of ink ejection.

Preferably, the first fluid is immiscible in the second fluid in order to maintain separation between the two fluids at the fluid interface. For example, the first fluid may be aqueous-based and the second fluid may be solvent-based.

Preferably, the second fluid is relatively less volatile than the first fluid.

Preferably, the ejection chamber has a larger volume than the bubble chamber.

Preferably, the first inlet has smaller dimensions than the second inlet.

Preferably, the first and second fluids are supplied in opposite directions via their respective first and second inlets.

As used herein, the term “ink” refers to any ejectable fluid and may include, for example, conventional CMYK inks (e.g. pigment and dye-based inks), infrared inks, UV-curable inks, fixatives, 3D printing fluids, polymers, biological fluids, functional fluids (e.g. sensor inks, solar inks) etc.

### BRIEF DESCRIPTION OF THE DRAWINGS

Embodiments of the present invention will now be described by way of example only with reference to the accompanying drawings, in which:

FIG. 1 a schematic sectional side view of an inkjet nozzle device in a quiescent state primed with first and second fluids;

FIG. 2 shows the inkjet nozzle device operating a bubble-collapse mode;

FIG. 3 shows the inkjet nozzle device operating in an initial stage of a bubble-venting mode; and

FIG. 4 shows the inkjet nozzle device in a subsequent stage of the bubble-venting mode.

### DETAILED DESCRIPTION OF AN EMBODIMENT OF THE INVENTION

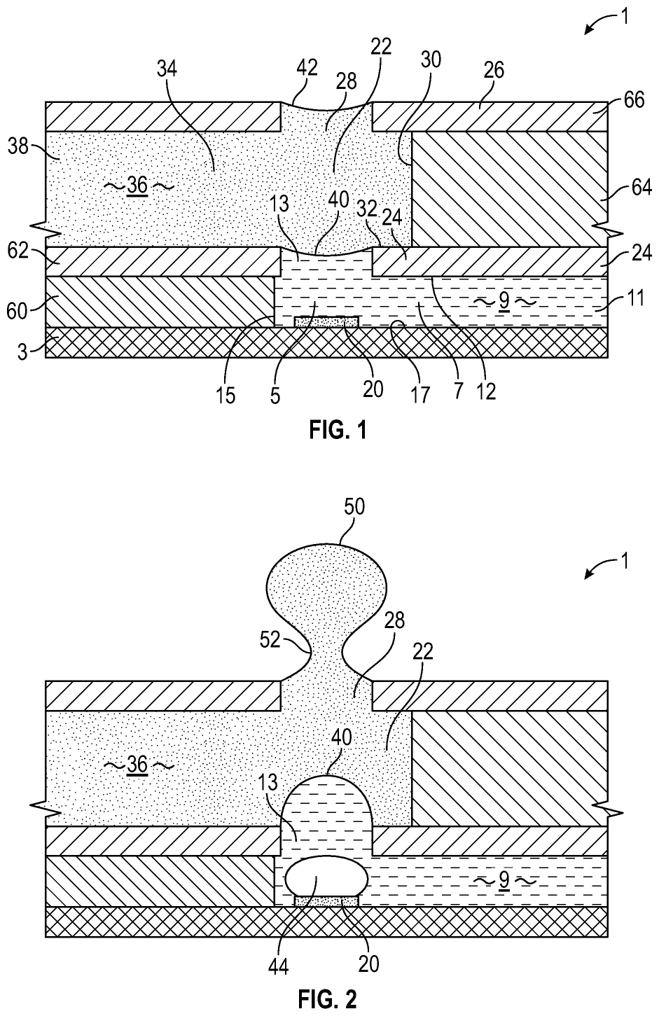

Referring to FIG. 1, there is shown a MEMS thermal inkjet nozzle device 1 according to one embodiment of the present invention. The inkjet nozzle device 1 is typically fabricated on an upper surface of a passivated silicon substrate 3 using conventional MEMS fabrication processes, such as those described in U.S. Pat. No. 7,819,503, the contents of which are incorporated herein by reference.

The inkjet nozzle device 1 comprises a lower bubble chamber 5 having a first inlet 7 supplying a first fluid 9 to the bubble chamber from a first fluid channel 11. The bubble chamber 5 comprises a ceiling 12 defining an orifice 13 and bubble chamber sidewalls 15 extending from the ceiling towards a bubble chamber floor 17. A resistive heating element 20 is disposed on the bubble chamber floor 17 beneath the orifice 13 and is electrically connected to electrodes in an upper metal CMOS layer of the silicon substrate 3 via suitable connections, as described in, for example, U.S. Pat. No. 8,967,772, the contents of which are incorporated herein by reference. The heating element 20 typically takes the form of an elongate bar heater and may be comprised of an aluminide alloy (e.g. TiAl or TiAlNbW alloy) coated with one or more protective layers (e.g. tantala and/or hafnia layers), as described in U.S. Pat. Nos. 9,994,017 and 9,573,368, the contents of which are incorporated herein by reference. Alternative heater element configurations and materials known in the art are, of course, within the ambit of the present invention.

The orifice 13 is positioned relative to the heating element 20 for communicating an impulse from a vapour bubble through the orifice 13. In order to maximize the force of the impulse through the orifice 13, the first inlet 7 may incorporate a first baffle (not shown) for constraining bubble growth and minimizing backflow of the first fluid 9 through the first channel 11 during actuation of the device. An example of a suitable baffle structure for the first inlet 7 is described in U.S. Pat. No. 8,998,383, the contents of which are incorporated herein by reference.

An ejection chamber 22 is positioned superjacent the bubble chamber 5, such that the ceiling 12 of the bubble chamber, having the orifice 13, defines an adjoining wall 24 between the ejection chamber and the bubble chamber. A roof 26 of the ejection chamber 22 defines a nozzle 28 for droplet ejection, and ejection chamber sidewalls 30 extend between the roof and the adjoining wall 24, which defines a floor 32 of the ejection chamber. The heating element 20, the orifice 13 and the nozzle 28 are aligned in a direction of ink ejection for maximizing device efficiency.

A second inlet 34 supplies a second fluid 36 to the ejection chamber from a second fluid channel 38. The second inlet 34 may incorporate a second baffle (not shown) for minimizing backflow of the second fluid 36 during actuation, as described above for the first inlet 7. The first fluid channel 11 and second fluid channel 38 generally extend away from the bubble chamber 5 and ejection chamber 22, respectively, in opposite directions parallel with a plane of the roof 26. This arrangement assists in channeling the first and second fluids separately through the silicon substrate 3 towards each inkjet nozzle device 1.

FIG. 1 shows the inkjet nozzle device 1 in a quiescent state. The first and second fluids 9 and 36 form a fluidic interface 40 at the orifice 13 by virtue of being immiscible fluids. Typically, the first fluid 9 is an aqueous-based fluid and the second fluid 36 is a solvent-based or oil-based fluid having minimal miscibility in the first fluid. The first fluid 9 may, for example, be water while the second fluid 36 may be a conventional solvent-based fluid used in offset or flexographic printing systems. Suitable examples of solvent-based or oil-based inks will be readily apparent to the person skilled in the art.

In the quiescent state, a meniscus 42 of the second fluid 36 in the nozzle 28 is concave by virtue of being pulled towards the ejection chamber 22 by a backpressure in a second fluid delivery system (not shown) supplying the second fluid to the ejection chamber. Likewise, the fluid interface 40 at the orifice 13 is correspondingly concave by virtue of a backpressure in a first fluid delivery system (not shown) supplying the first fluid 9 to the bubble chamber 5.

The inkjet nozzle device may be operable in two different modes (a bubble-collapse mode and a bubble-venting mode), depending on the profile of a firing pulse received by the heating element 20 as well as inherent physical properties of the first and second fluids 9 and 36.

FIG. 2 shows the inkjet nozzle device 1 in a bubble-collapse mode shortly after actuation of the heating element 20. In this mode, a vapour bubble 44 is formed immediately above the heating element 20, which tends to push the fluid interface 40 at the orifice 13 outwards towards the nozzle 28. The first fluid 9 is typically relatively more volatile than the second fluid 36 to ensure bubble formation only in the first fluid.

The impulse from the vapour bubble 44, in turn, pushes the second fluid 36 outwardly into a droplet 50, which is separated from the nozzle 28 by a neck portion 52. Subsequent collapse of the vapour bubble 44 onto the heating element results in droplet ejection with concomitant refilling of the bubble chamber 5 and ejection chamber 22 via suction and capillary forces. The bubble-collapse mode of operation is relatively low energy and provides a relatively low bubble impulse. This mode may be suitable for ejection of second fluids 36 have a relatively low surface tension and/or viscosity. Advantageously, the bubble-collapse mode does not result in ejection of any of the first fluid 9 with the second fluid 36, which is advantageous in terms of print quality. However, bubble-collapse mode may be disadvantageous in terms of device lifetime due to cavitation forces from the collapsing vapour bubble 44, which are directed onto the heating element 20. Furthermore, the relatively low bubble impulse may be somewhat limiting for the range of ejectable second fluids 36.

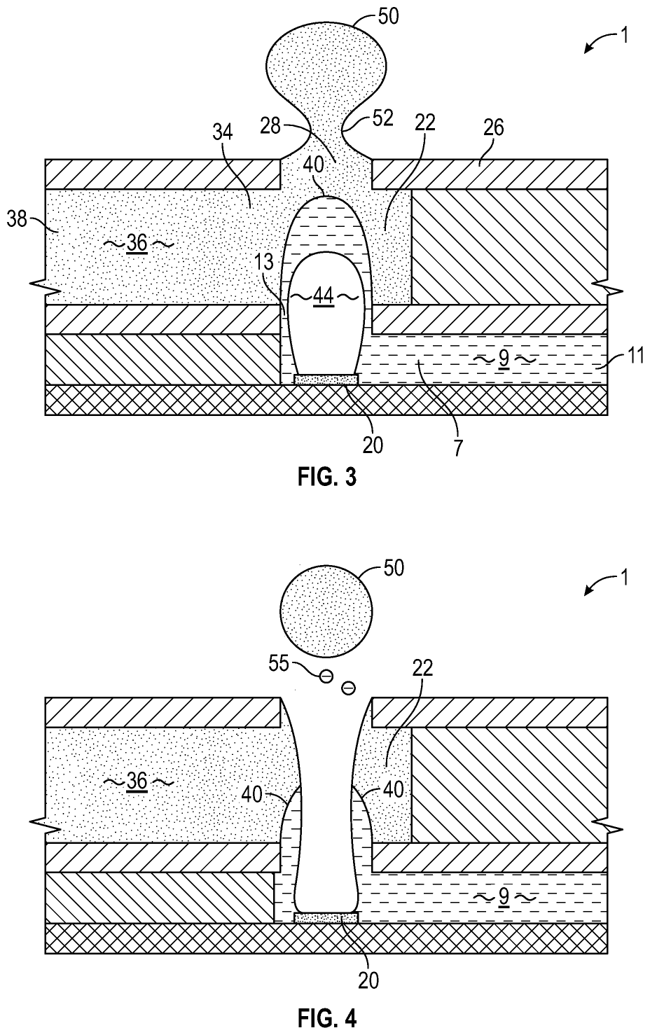

FIGS. 3 and 4 show the inkjet nozzle device 1 operating in a bubble-venting mode. Suitable parameters for a bubble-venting mode of operation in a thermal inkjet device are described in U.S. Pat. No. 9,060,797, the contents of which are incorporated herein by reference. Referring to FIG. 3, a relatively higher energy firing pulse produces a relatively higher impulse vapour bubble 44, which extends through the orifice 13 into the ejection chamber 22. Likewise, the fluid interface 44 bulges outwardly beyond the vapour bubble 44 towards the nozzle 28; however, the fluid interface 40 remains intact throughout bubble generation. The impulse from the vapour bubble 44, in turn, pushes the second fluid 36 outwardly into a droplet 50, which is separated from the nozzle 28 by a neck portion 52.

Referring to FIG. 4, a main droplet 50 of the second fluid 36 has ejected from the nozzle 28, while the expanding vapour bubble 44 has vented to atmosphere via the nozzle 28. Venting of the vapour bubble 44 inevitably produces one or more trailing satellite droplets 55 of the first fluid 9 as the vapour bubble condenses. However, since the satellite droplet(s) 55 of the first fluid 9 are very small relative to the size of the main droplet 50 of second fluid 36, the impact on overall print quality is relatively small. As shown in FIG. 4, the fluid interface 40 is maintained between the first and second fluids 9 and 36 during bubble venting.

Advantageously, the bubble-venting mode, having a relatively higher bubble impulse, may be used for ejection of ejection of second fluids 36 having a relatively higher viscosity and/or surface tension. Furthermore, the absence of cavitation forces on the heating element 20 usually results in extended device lifetimes compared to the bubble-collapse mode. However, the bubble-venting mode may be disadvantageous in terms of print quality since a small quantity of the first fluid will be ejected from the nozzle 28 as satellite droplets 55.

In either the bubble-collapse mode (FIG. 2) or the bubble-venting mode (FIGS. 3 and 4), the bubble chamber 5 and ejection chamber 22 refill with the first fluid and second fluids 9 and 36, respectively, by virtue of suction and capillary forces in the first fluid channel 11 and second fluid channel 38, respectively. The first fluid 9 has a relatively higher surface tension than the second fluid 38 and, therefore, refilling of the bubble chamber 5 is faster than refilling of the ejection chamber 22. Relatively smaller dimensions of the first inlet 7 compared to the second inlet 34 further increase capillarity and further assist with fast refilling of the bubble chamber 5. Relatively faster refilling of the bubble chamber 5 is important, especially in the bubble-venting mode, so that a robust meniscus of the first fluid 9 is initially formed across the orifice 13 immediately after droplet ejection. With a robust meniscus formed across the orifice 13, the second fluid 36 is refilled relatively more slowly over this meniscus to form the fluid interface 40 and without the second fluid entering the bubble chamber 5.

From the foregoing, it will be appreciated that the inkjet nozzle device 1 advantageously provides a means for ejecting a range of second fluids 36, including non-volatile fluids, using thermal bubble-forming inkjet technology. The inkjet nozzle device 1 may be configured for different modes of operation, as described above, depending on the requirements of a particular application.

As foreshadowed above, the inkjet nozzle device 1 is amenable to fabrication on a CMOS wafer using known MEMS fabrication techniques. In principle, four deposition and etching steps can be used to construct the inkjet nozzle device on the silicon substrate 3: (1) deposition of a layer of bubble chamber material 60 and etching to define the bubble chamber 5 and first fluid channel 11; (2) deposition of a layer of ceiling material 62 and etching to define the orifice 13; (3) deposition of a layer of ejection chamber material 64 and etching to define the ejection chamber 22 and second fluid channel 38; and (4) deposition of a layer of nozzle plate material 66 and etching to define the nozzle 28. Any suitable material (e.g. silicon oxide, silicon nitride etc) may be used for the deposition steps, and each layer may be the same or different. For example, all layers may be silicon oxide layers. As described in U.S. Pat. No. 7,819,503, voids in the deposited oxide layers are typically filled with a sacrificial material (e.g. photoresist) to provide a planar scaffold for deposition of subsequent layers.

It will, of course, be appreciated that the present invention has been described by way of example only and that modifications of detail may be made within the scope of the invention, which is defined in the accompanying claims.

1. An inkjet nozzle device comprising:
a bubble chamber having a heating element for generating a vapour bubble and an orifice positioned for communicating an impulse from the vapour bubble;
a first inlet for supplying a first fluid to the bubble chamber;
an ejection chamber having a roof defining a nozzle and an adjoining wall between the ejection chamber and the bubble chamber, the adjoining wall defining the orifice; and
a second inlet for supplying a second fluid to the ejection chamber,
wherein, in use, the first and second fluids form a fluidic interface at the orifice and the vapour bubble provides the impulse to the second fluid in the ejection chamber via the orifice, said impulse ejecting the second fluid from the nozzle.

2. The inkjet nozzle device of claim 1, wherein the adjoining wall defines a ceiling of the bubble chamber and a floor of the ejection chamber.

3. The inkjet nozzle device of claim 2, wherein the heating element is disposed on a floor of the bubble chamber.

4. The inkjet nozzle device of claim 3, wherein the heating element, the orifice and the nozzle are aligned in a direction of ink ejection.

5. The inkjet nozzle device of claim 1, wherein the first fluid is immiscible in the second fluid.

6. The inkjet nozzle device of claim 1, wherein the first fluid has a relatively higher surface tension than the second fluid.

7. The inkjet nozzle device of claim 1, wherein the second fluid is relatively less volatile than the first fluid.

8. The inkjet nozzle device of claim 1, wherein the first fluid is aqueous-based and the second fluid is solvent-based.

9. The inkjet nozzle device of claim 1, wherein the ejection chamber has a larger volume than the bubble chamber.

10. The inkjet nozzle device of claim 11, wherein the first inlet has smaller dimensions than the second inlet.

11. The inkjet nozzle device of claim 1, wherein the first and second fluids are supplied in opposite directions via their respective first and second inlets.
